(19) United States
(12) Patent Application Publication
(10) Pub. No.: US 2009/0248445 A1
(43) Pub. Date: Oct. 1, 2009

(54) PATIENT DATABASE

(76) Inventor: PHIL HARNICK, Sherman Oaks, CA (US)

Correspondence Address: DLA PIPER US LLP, 1999 AVENUE OF THE STARS, SUITE 400, LOS ANGELES, CA, 90067-6023, US

(21) Appl. No.: 12/268,400

(22) Filed: Nov. 10, 2008

Related U.S. Application Data
(63) Continuation-in-part of application No. 12/267,537, filed on Nov. 7, 2008.
(60) Provisional application No. 60/986,836, filed on Nov. 9, 2007.
(60) Provisional application No. 61/105,404, filed on Oct. 14, 2008.

(51) Int. Cl. G06Q 50/00; G06Q 30/00

(52) U.S. Cl. 705/3; 705/14.49; 705/2

(57) ABSTRACT

The system provides a patient-oriented healthcare website, where patients can a) securely post-visit review their medical record, (using a password and not any name information whatsoever), including their symptoms and the doctor-prescribed treatment plan; b) an easy on-line feedback system (were you satisfied with your treatment? Did you get better or worse? How long did it take to get better? Did you have any adverse reactions to medication? Etc.); c) high-value pharma and other industry clicks specific to the patient's conditions, e.g. high blood pressure, arthritis. Patients can then go to subsequent physicians offices, where the doctor can review prior medical records on our website.

This patent application claims priority to U.S. provisional patent application 60/986,836 filed Nov. 9, 2007 entitled “Patient Intake System”, U.S. provisional patent application 61/105,404 filed Oct. 14, 2008 entitled “Improved Patent Intake System”, each of which is incorporated by reference in their entirety herein.

This patent application is a continuation-in-part of U.S. patent application Ser. No. 12/267,537 filed Nov. 7, 2008 entitled “Patient Intake System” which is incorporated by reference in its entirety herein.

### BACKGROUND OF THE SYSTEM

When a patient visits a doctor, either in an office or emergency room, there is a need to obtain information from the patient. Some of the information is historical and relates to the patient's medical history. Also needed is information about the reason for the visit, such as an injury, pain, or illness. Typically a patient will fill out a medical history (particularly when it is the first visit with a doctor) while waiting to see the doctor. If the patient already has historical information on file, the patient may still be asked to fill out a form relating to the current reason for the visit. This typically is merely a few lines and can only be filled out in a summary manner.

When the patient meets the doctor, the doctor will typically ask a series of questions about the patient's complaint, making notes and following possible diagnosis paths by branching to appropriate questions based on the patients responses. After the visit the doctor may hand notes to an assistant for transcribing or may dictate a summary of the visit into a recorder for later transcription.

There are a number of disadvantages with the current system of patient doctor interaction. First there is a great deal of wasted time going through the questions so that the doctor can get to the point of the visit. It is only after this question and answer period that the doctor can really begin meaningfully examining the patient's complaint and planning a course of treatment or investigation. Many of the questions the doctor are the same for each patient, which becomes repetitious for the doctor. Another disadvantage is the fact that the doctor must take notes or make a recording of the responses that is later retyped or transcribed, wasting staff resources. Each doctor typically employs a unique format or method for the data acquired, so that it is not easy to share data among and between doctors and other health professionals. Additionally, doctors do not consistently gather and document symptoms, making aggregate analysis nearly impossible; communications difficulties often exist between doctors and patients; doctors are not always aware of up-to-the-minute symptoms related to disease outbreaks; and each doctor patient encounter is limited by the individual doctor's education, personal experiences, time constraints, and preconceptions.

Another disadvantage of the current system is the lack of accessibility of the medical records and patient response by the patients themselves. Although a patient has the right of access to the patient's own medical records, the process is burdensome and the records themselves are not very accessible to a non-medical professional. In addition, the patient is required to make separate requests from all doctors, hospitals, and/or labs where patient records might reside. Finally, when seeing a new medical professional, the records must again be obtained by the medical professional. The lack of standards in record keeping among medical professionals could create a risk to the patient if information is not clearly conveyed and historical information not accurately represented.

### SUMMARY OF THE SYSTEM

The system provides a patient-oriented healthcare website, where patients can a) securely post-visit review their medical record, (using a password and not any name information whatsoever), including their symptoms and the doctor-prescribed treatment plan; b) an easy on-line feedback system (were you satisfied with your treatment? Did you get better or worse? How long did it take to get better? Did you have any adverse reactions to medication? Etc.); c) high-value pharma and other industry clicks specific to the patient's conditions, e.g. high blood pressure, arthritis. Patients can then go to subsequent physicians offices, where the doctor can review prior medical records on the website.

In one embodiment the system uses a data entry device for a patient to enter historical and/or current information. The system utilizes intelligent routing so that the patient is guided to meaningful question paths based on answers to prior questions. The system includes graphical and audio capabilities to help the patient provide accurate information. The system contemplates the user entering data prior to meeting with the doctor. When the doctor sees the patient, the doctor already has the patient responses available in full and summary format, and the patient is more contemplative of their personal medical history, current condition, and symptoms, facilitating a more meaningful and productive encounter. The format is consistent from patient to patient and is uniform for all doctors using the system. This allows data to be easily compiled and shared by health professionals. This shared data can aid in indicating epidemics and geographic progressions of ailments and diseases. The data can also be used to aid in diagnosis of patients.

In one embodiment, the doctor will transfer the patient data to a central database. Along with the patient data, the doctor can transmit an initial diagnosis, treatment plan, and results of the treatment plan. In this manner, statistical information can be built up that can indicate more accurate diagnoses when similar fact patterns are presented by patients. The efficacy of treatment plans will also have large statistical populations that can be analyzed and studied. One embodiment contemplates a feedback loop to doctors so that when they meet with a patient who has presented certain symptoms, the doctor is presented with the statistical evidence of various diagnoses associated with that set of symptoms, the accuracy of the diagnoses, the geographical distribution of the cases, treatment plans and their success rates, and other relevant statistical data.

In another embodiment, the patient can opt to create or populate an existing patient account in a third party online personal health record. For example, an online personal health record referred to as HealthVault and provided by Microsoft is available. There are other systems offered by others, including AOL, Google, and others.

### BRIEF DESCRIPTION OF THE DRAWINGS

FIG. 1 is a flow diagram illustrating the operation of an embodiment of the system.

FIG. 2 is a flow diagram illustrating an embodiment of the modules of the system.

FIG. 3A is an interface for a patient to indicate the location of a complaint.

FIG. 3B is an interface that shows an expanded view of a selected location.

FIG. 4 is a flow diagram of the operation of the complaint module.

FIG. 5 is a user interface for a patient to indicate an amount of pain.

FIG. 6 is a flow diagram of the systems review module.

FIG. 7 is a flow diagram of the medical history module.

FIG. 8 is a flow diagram of the social/family history module.

FIG. 9 is an example of an interface for use by a provider.

FIG. 10 is an example computer system that can be used to implement the system.

FIGS. 11A-11D are examples of a patient history presented to a provider.

FIGS. 12A-12B illustrate single choice entry forms.

FIGS. 13A-13B illustrate multi-choice entry forms.

FIGS. 14A-14B illustrate alpha/numeric entry forms.

FIGS. 15A-15B illustrate interactive entry forms.

FIG. 16 is a flow diagram illustrating the operation of an embodiment of the system.

FIG. 17 is a flow diagram illustrating the operation of a feedback embodiment of the system.

FIG. 18 is a flow diagram illustrating one embodiment of the operation of the family connection scheme of the system.

FIG. 19 illustrates an embodiment of a data entry screen that may prompt the patient to update or create a third party health information account.

FIG. 20 is a flow diagram illustrating a data collection method of the system.

FIG. 21 is a flow diagram illustrating use of an embodiment of the system in assisting diagnosis and treatment.

### DETAILED DESCRIPTION OF THE SYSTEM

The present system provides a method and apparatus for acquiring patient data and maintaining the data in a central uniform database. The data is associated with a patient in one embodiment via a unique patient identifier. The patient's name or other identifying information is never made available to preserve confidentiality. Even if the data were somehow leaked, only the unique identifier would be known, and not the individual identity information.

The data is maintained in the database in a consistent format so that the data is easily understandable and searchable. The patient can easily access the data at anytime via a password and unique user name or identifier. The data is updated nearly immediately after a visit to a medical professional. When a patient visits a new doctor, the patient can make the database information available to the new medical professional, reducing the chance of something important in the patient's medical history being missed or mistaken.

Patient Data Intake

The present system provides a method and apparatus for acquiring patient intake data. In one embodiment, the system includes an interactive computer based questionnaire that guides a patient through an intake procedure using text, graphics, video, and audio. The system includes intuitive and simple navigation and allows the patient to easily back up to any previous section to revise answers. Based on answers provided by the patient, the system routes itself to appropriate lines of questions for that patient. In one embodiment, the system utilizes a standalone entry device such as a tablet PC, touch screen tablet, or the like. In other embodiments, the user accesses the system via work stations in a waiting room or even from a home, office or other web-enabled computer/device prior to arriving at the doctor's office.

The system seeks to provide ease of use for the patient, similar to operating a bank ATM for example. The system should also provide rapid application familiarity: with the design geared towards making the user immediately comfortable and increasing that comfort level through the inherent consistency and simplicity of the system. The placement of buttons in consistent positions, the tone and length of the questions, consistent and predictable form layouts; all contribute to rapid familiarity, acceptance, and speed of operation of the application by a user, even one who has never used it before.

Rather than maximizing information gathered on a single screen, the design utilizes more but simpler screens, which provides for a faster patient session; the user doesn't have to stop and think about any given question, and gets into a comfortable flow with the system. The system makes use of appropriate animated images for user choices to speed operation, and minimize confusion. Multi-language support is provided both textually and via audio as desired. The user can mute the audio at will and use it only when the user feels necessary.

To increase ease of use and familiarity, the system in one embodiment employs certain “Common buttons” that can be easily enabled or disabled for any question, that are always in the same geographic region of the screen. These may include “Don't Know”, “Some Other Answer”, and “No/None of These”;

In one embodiment, Help is available to the user on every screen of the system, including “What do you mean, Doc?”, and “Why do you want to know?”, as well as a list of all the questions and answers “so far” in the patient session, and access to a “Guided Tour” of the system.

The system uses a particular language and interface with the patient to aid in the ability of the patient to understand and participate in the process. In one embodiment, he results of the data entry may then be mapped to different language and representations for the benefit of the doctor. One example of this may be the use of graphically represented pain indicators for the patient that provide an intuitive way for the patient to rate the pain the may be feeling. When presented to the doctor, that data may be mapped to a standard pain scale that has more meaning to the patient's doctor and to other providers who may later encounter the data. Examples of pain scales include the Wong-Baker Faces pain scale for pediatric use and the Schmidt Sting Pain Index.

Data Intake Operation

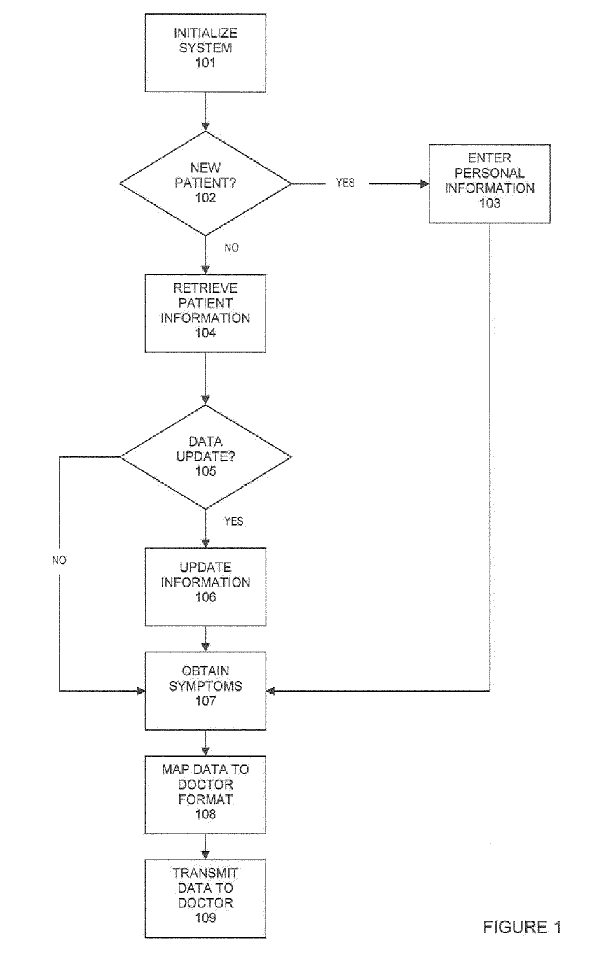

FIG. 1 is a flow diagram illustrating the operation of an embodiment of the system. At step 101 the system is initialized. This may take the form of a patient being provided with a handheld entry device, such as a tablet or touch-screen computer, by having the patient log onto a computer station at the health provider's premises (e.g. waiting room), or by logging onto a web site using some other computer (such as the patient's own computer). Ideally the patient will interact with the system in advance of the patient's actual appointment with the physician. In fact, in one implementation, any appointments with a health care provider are made by informing the patient of the system and explaining that their appointment time is first for providing data and then followed by an appointment with the provider. If the system is in place and used widely, the promptness and reliability of an appointment could be greatly enhanced.

At step 102 the system determines if the present user is a new patient. If so, the system loops to step 103 and the patient is prompted to enter personal information into the system. This process may include name and address, age, identification, insurance, etc.

At step 104, if the patient is an existing patient or is a patient who has already entered data into the system, the patient information is retrieved. This may be from a local database associated just with the particular provider, from a central database that is associated with the patient, or from some other source. In one embodiment, the patient information is kept in a central database which may be a system managed database, a third party database, or a regulated database (e.g. a state or county managed database). In some embodiments, the provider is only able to access certain information from the database, such as data related to the physician's field of expertise. In other instances, the patient can electronically authorize permissions for the provider to have full access to the patient records.

At step 105 the patient is asked if there are any updates or changes to the patients personal information. This may be accomplished by presenting the patient with a display of the personal information and asking if it is correct. If there are changes to be made, the patient makes them at step 106. If not, then the system advances to step 107 (a new patient is advanced to step 107 after completion of step 103). At step 107 the system begins obtaining the symptoms/condition information that are the purpose of the present visit to the provider. This is accomplished using a series of unique interfaces and queries using the system. As the patient answers questions and provides information, the patient is routed to other relevant queries to provide a complete picture that can be used by the provider. A goal of the system is to at least duplicate, or exceed, the type of information that the provider would elicit during an in-person interview with the patient.

After the patient has provided symptom/condition data at step 107, the system maps the data into a format that can be used by the doctor. The system uses language and graphics geared to the patient to make it more natural for the patient to provide useful information. However, this information can be mapped or translated into a form that is more natural for the provider to use. At step 109, the transformed data is transmitted to the provider for use with the patient. This transmission may be accomplished simply by returning the loaned hand-held computer to a provider representative, clicking a “finished” icon at the on-site system, or by initiating a transfer from a patient computer or website.

Modules

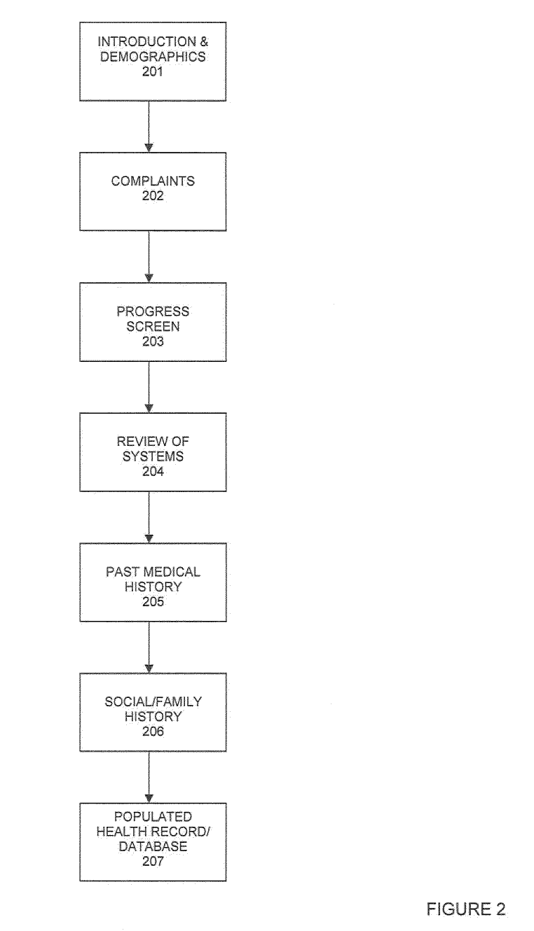

In one embodiment, the system is configured in a series of modules that guide the flow of data entry by the patient. FIG. 2 is a flow diagram illustrating an embodiment of the modules of the system. Module 201 is the introduction and demographics module. This module initializes the system and is used to obtain and/or update personal information of the user. If the user has already used the system before, module 201 is where the user could sign in with a username and password to access previously entered data. A new user can pick a username/password combination so that future sessions can be more efficient. In addition to personal identification information, this module may be used to identify insurance/payment information.

After the introduction and demographics module, the system proceeds to the complaints module 202. This module is where the patient will identify the reason for the visit to the provider. Progress module 203 tracks completion of information by the user and provides periodic or continuous presentation of status so that the patient can see how far they have to go to complete the data entry. Systems review module 204 is used to gather data about different aspects of a patient, such as vision, cardiovascular, pulmonary, gastrointestinal, etc. Medical history module 205 is used to take the medical history of the patient. This module is typically most time consuming the first time that a patient uses the system. Afterwards, the history entered is always available, and the history is updated automatically every time the patient uses the system. Thereafter, there is no need for the patient to interact with this module directly, although it is available to the provider.

The social/family history module 206 is used to provide family background for the patient. In one embodiment, patients from the same family can authorize the automatic updating of the family history module of one patient by all other family patients using the system. In other embodiments, the patient will review the family history module 206 and update it accordingly as appropriate. Database module 207 is a populated health record database for the patient that can be accessed by the patient and any authorized receivers (i.e. physicians and other providers). In one embodiment, this module can be made anonymously available to a central database for statistical analysis of trends, treatments, possible epidemics, geographical distribution of ailments, etc.

Complaint Module 202

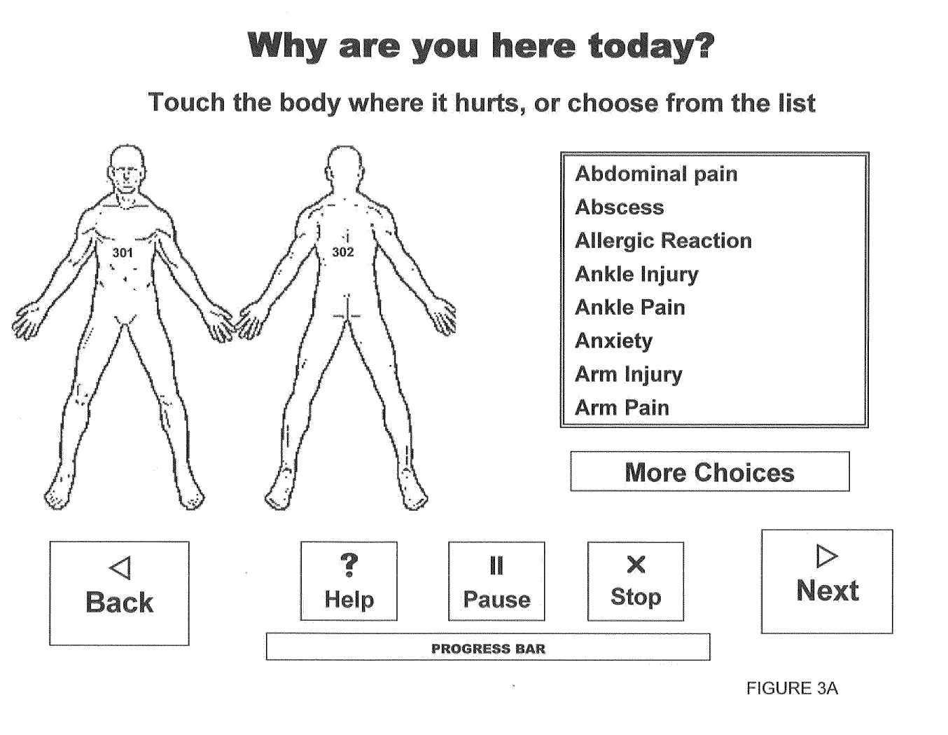

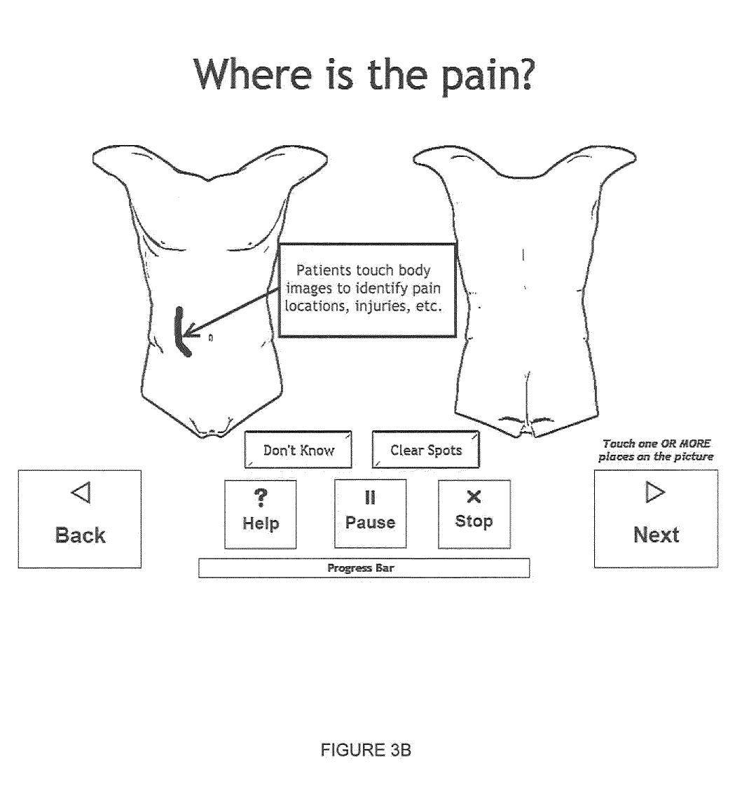

The complaint module 202 may present to the patient as shown in FIGS. 3A and 3B. In FIG. 3A the user is presented with an image of the front 301 and back 302 of a human figure along with a list of possible ailments. The patient can begin the process by simply clicking or touching on the part of the body that is the source of illness or complaint. When a portion of the body is touched, the patient is presented with a close up of that body section such as is shown in FIG. 3B. The close up view allows the patient to be more specific in identifying the location of the problem. Each entry or selection by the patient is captured in a database by the system. The location of the problem area by the patient is mapped or identified with the appropriate name or area of the body for review by the provider. In one embodiment, the patient can draw directly on the screen with a finger or mouse or other tracking device to more clearly indicate specific areas of interest, such as shown by the line on the left torso of FIG. 3B.

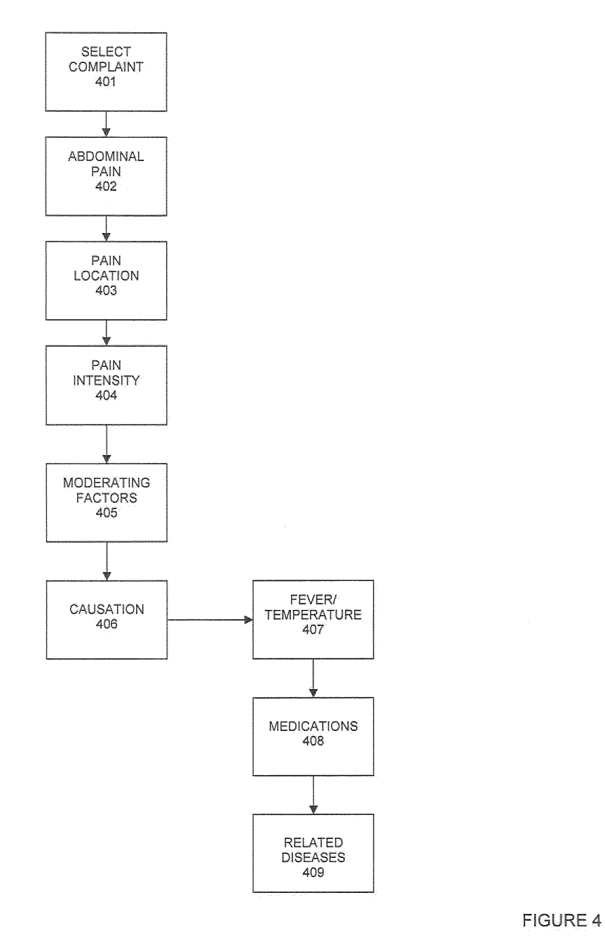

One example of the flow of the complaint module is illustrated in FIG. 4. At step 401 the particular complaint is selected. At step 402 the complaint is identified (in this example abdominal pain). At step 403 the pain location is identified. These first three modules can be accomplished using the interface of FIG. 3A and FIG. 3B, for example. At step 404 the pain intensity is determined. At step 405 moderating factors are obtained (if any). At step 406 causation is attempted to be determined. At step 407 any associated fever/temperature information is obtained. At step 408 medications are identified and related diseases are obtained at step 409. This flow is meant to be exemplary only and may be accomplished in a different order or with more or fewer steps as desired. In some cases, the nature of the complaint will result in branching and presentation of different requests to the patient.

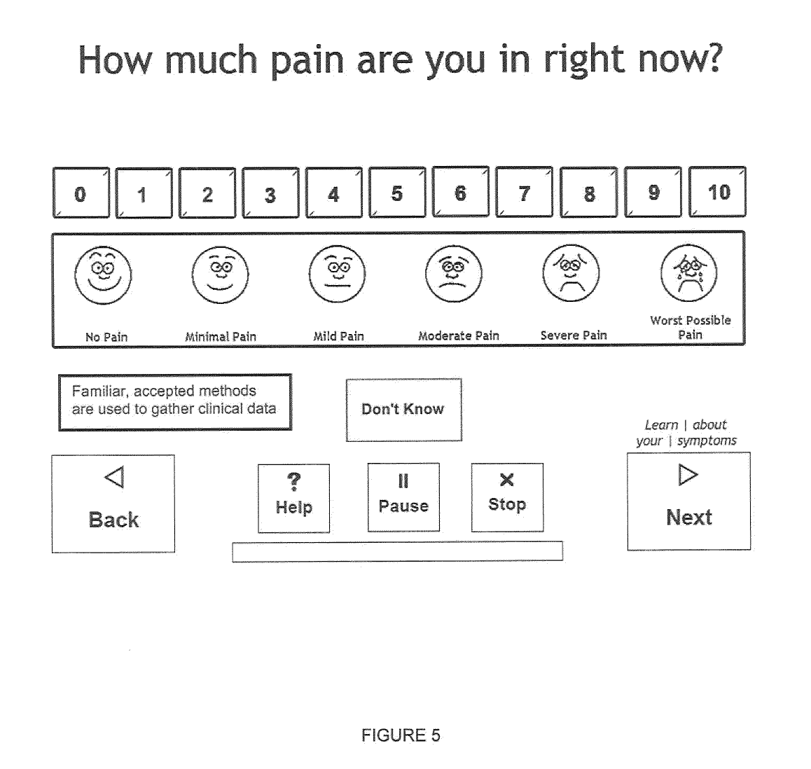

An example of pain indication is shown in FIG. 5. Here the patient is presented with both graphical and textual indicators of pain levels and selects one that represents the pain associated with the complaint. As seen in FIG. 5, the level of pain can be represented numerically on a scale of 1-10. The patient can simply select one of the numerical representations to indicate the level of pain. Sometimes a patient isn't sure what the correct pain level would be. To assist such patients, the system also includes graphical indicators that include a drawing of a face identified by a title representing the amount of pain. In those cases, a patient can simply click on one of the graphical icons that best represents the level of pain. Regardless of the method in which the user identifies the amount of pain, the choice is converted to a standard scale or to some form that the provider can meaningfully use to assist in the diagnosis.

Systems Module 204

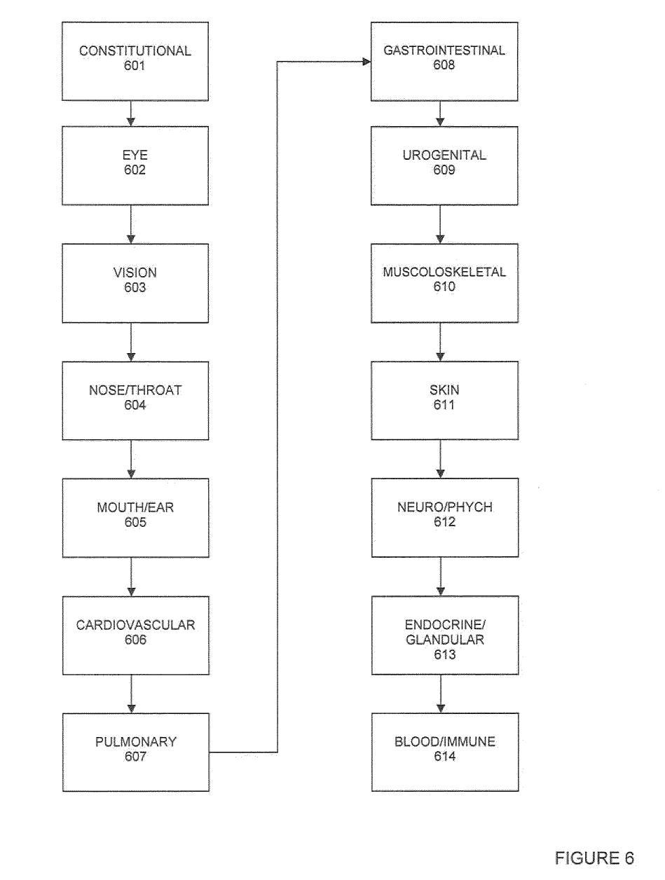

An example of one embodiment of the flow of the systems module 204 is illustrated in FIG. 6. The patient is led through a number of the physical systems and is presented with input screens where the patient can indicate relative health and condition of the systems. In the example of FIG. 6, the patient is asked about the constitutional system at step 601. This asks the patient about overall health, fitness, tiredness, etc. At steps 602 and 603 the patient is asked about eyes and vision. At step 604 the patient provides information about the nose and throat while step 604 inquires about the mouth and ear.

Cardiovascular and pulmonary information is obtained at steps 606 and 607. Step 608 addresses the gastrointestinal system. Step 609 requests information about the health of the urogenital system (adapted to the sex of the patient). Musculoskeletal and skin systems are examined in steps 610 and 611. Questions about the neuropsychological system are presented at step 612. Review of the endocrine/glandular system and blood/immune system or done at steps 613 and 614.

Past Medical History Module 205

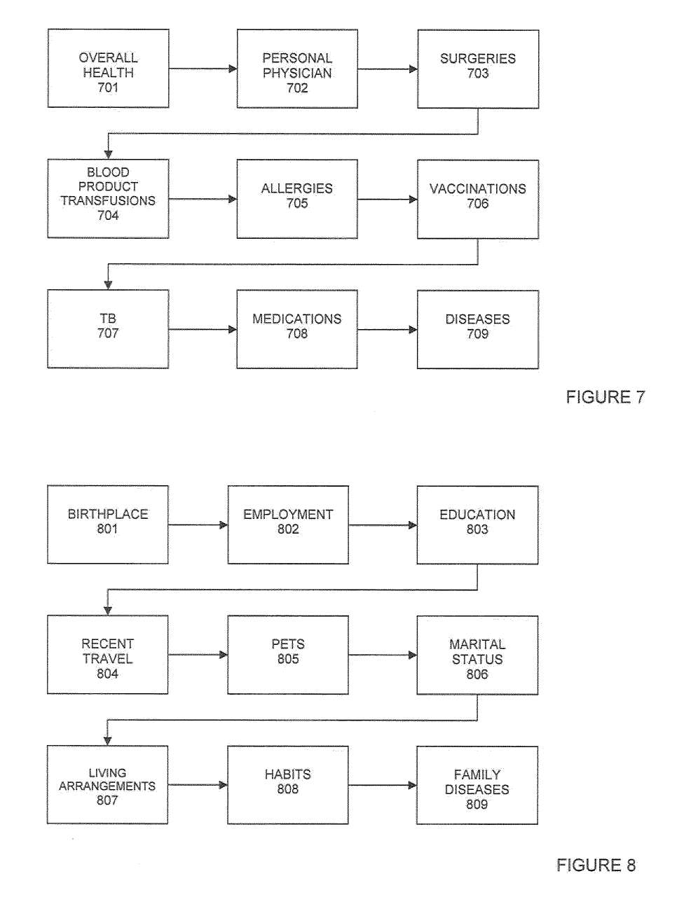

FIG. 7 is a flow diagram illustrating one embodiment for obtaining a past medical history. The patient is presented with a series of interfaces related to the steps of FIG. 7 including overall health at step 701, personal physician at step 702 and history of surgeries at step 703. At step 704 the patient is asked about blood transfusions while at steps 705 and 706 information about allergies and vaccinations is obtained. The system asks about TB history at step 707, present and past medications at step 708 and past and present diseases at step 709. When the patient has already entered data into the system, the medical history module can be populated by prior answers to these questions. In addition, when the patient is treated for a current problem, that problem, and any associated treatments, procedures, and prescriptions, may be automatically provided to this module to keep it current.

One risky area in doctor/patient interaction is the failure of the patient to fully inform the doctor of an accurate medical history. The system makes it easier to provide a complete as well as up-to-date history to a provider.

Social/Family History Module 206

FIG. 8 is a flow diagram for obtaining social and family history. At step 801 the system obtains birthplace information. At steps 802 and 803, employment and education histories are provided. Step 804 identifies recent travel while step 805 inquires about pets. Marital status and living arrangements are provided at steps 806 and 807. Step 808 asks about habits, such as drinking, smoking, exercise, drug use, etc. Step 809 requests information about family diseases. In one embodiment, family members can elect to permit automatic update of the family history module for each participating member whenever any member uses the system.

Presentation to Provider

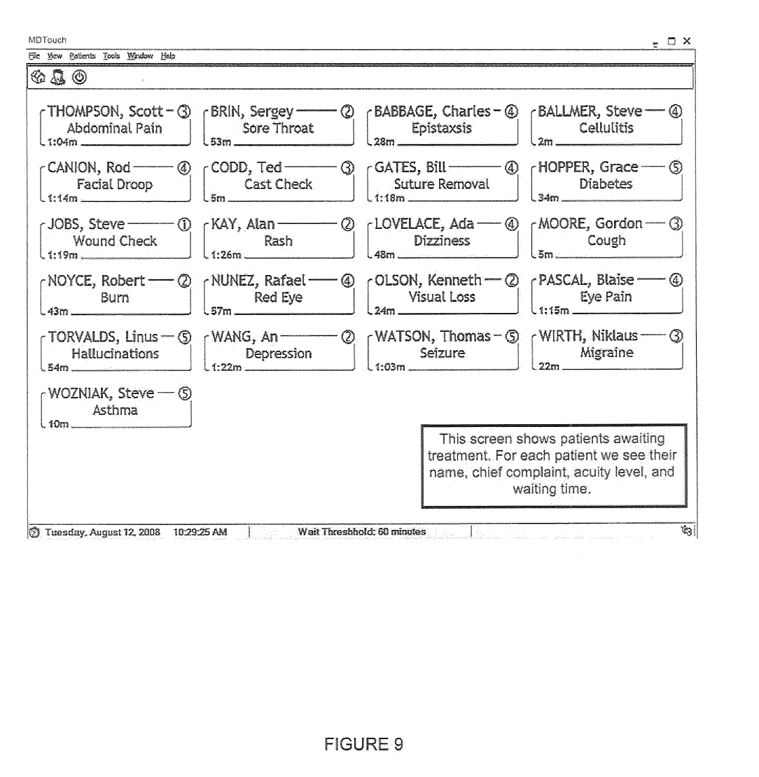

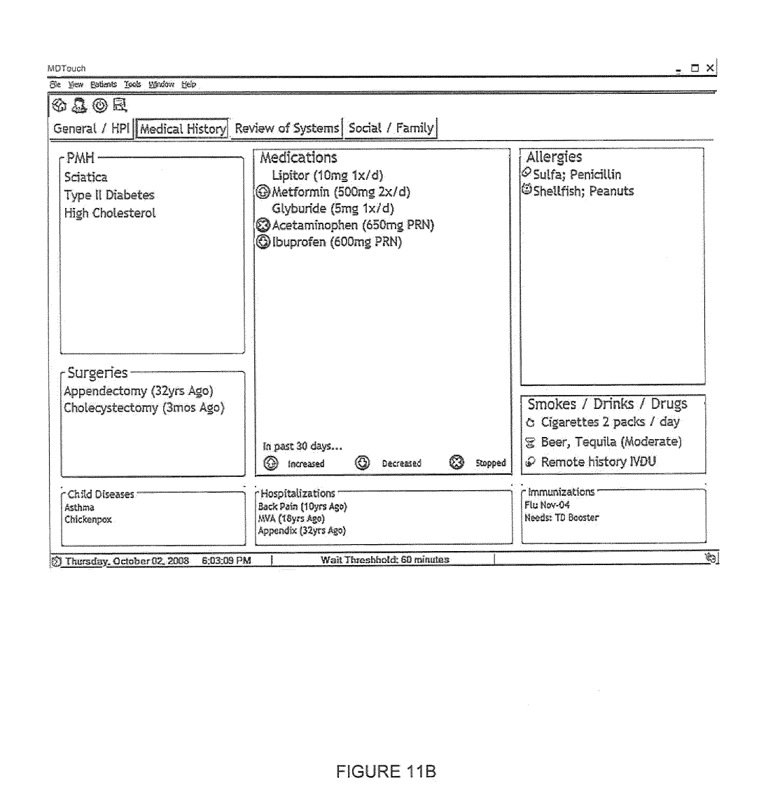

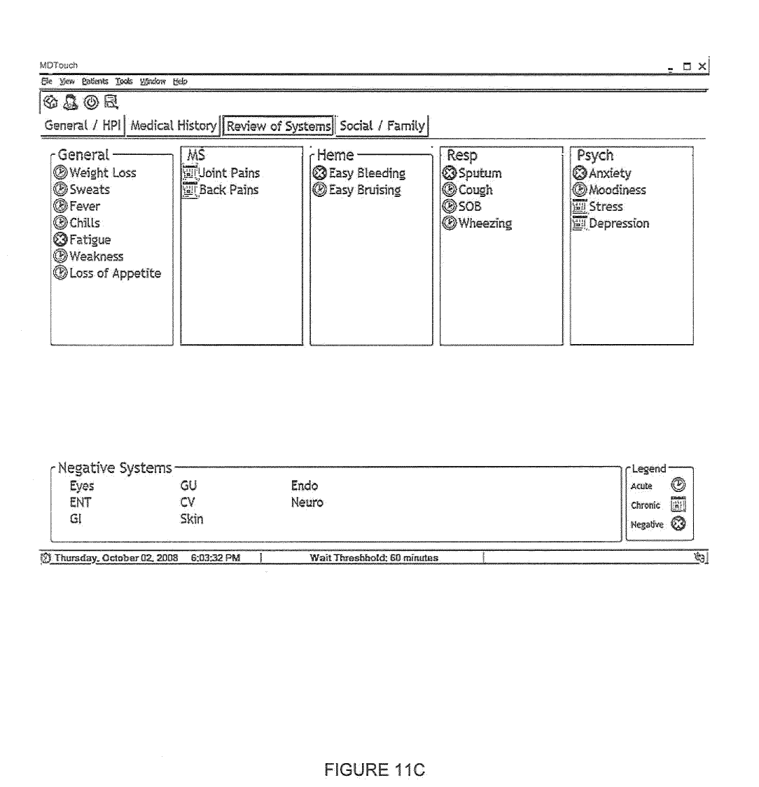

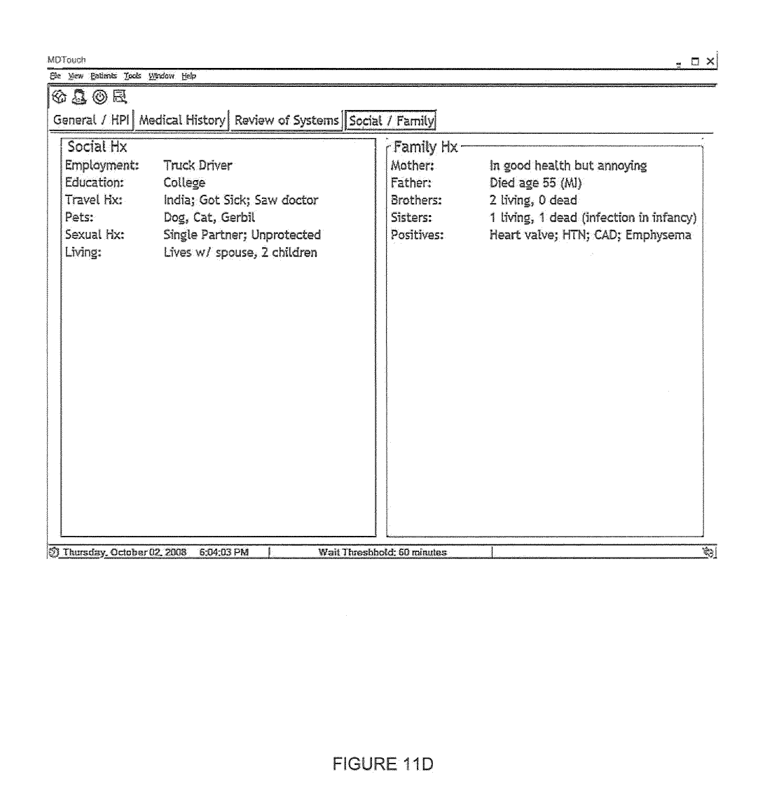

FIG. 9 is an example of the presentation of a plurality of patient databases to a provider in one embodiment. In FIG. 9, a number of patients appear on a providers screen. Each patient is identified by name and has a small field that identifies the patient's chief complaint, acuity level (e.g. pain or urgency level), and waiting time. Optionally the system may show the appointment time as well. Clicking or selecting one of the patients produces an expanded view of the patient data as shown in FIGS. 11A-11D.

FIG. 11A illustrates an example of how patient information might be presented to a provider. The data is separated by a plurality of tabs (e.g. general, medical history, review of systems, social/family). Selecting one of the tabs shows the data associated with that section. FIG. 11A illustrates the General/HP tab and includes the patients physical data (height, weight, age etc), vital signs (temp, blood pressure, pulse etc.) and the principal complaint. Information that has been provided by the patient has been mapped/translated into a form that is most usable by the provider. For example, the physical location is described more anatomically as appropriate for a provider. The image that the patient used to indicate the location of the pain is also presented so that the provider can double check the mapping/translation. Summaries of the responses provided by the patient are presented on this page.

FIG. 11B illustrates the medial history tab. This enables the provider to make any links or connections between the patient history (including allergies) to the present ailment. FIG. 11C illustrates the review of systems tab and lists characteristics and short graphical indicators representing the state or condition of the systems. In one embodiment, only those systems and characteristics that are identified in any way other than normal are presented to the provider. The normal or negative systems may be listed a shown in the lower box of FIG. 11C.

FIG. 11D shows the social/family history data so that any applicable information may be used by the provider to provide the most accurate diagnosis.

Form Types

The system defines and utilizes a plurality of form types for presenting questions/information to the patient. Different form types are used to present question/answer/information to the user in specific ways to simplify program operation for the user. In one embodiment, all form types include certain common buttons and navigation tools, including the back and next buttons, the sound, help, and stop buttons, the progress bar, and the labels for the question that is the subject of the form and a subquestion that helps explain the question or puts it in appropriate context.

In one embodiment, the system uses one or more form types such as “Pick One”, “Pick Many”, “Alpha/Numeric”, and “Interactive”. Other form types may be used and these form types may be combined on a single form as desired.

Pick One

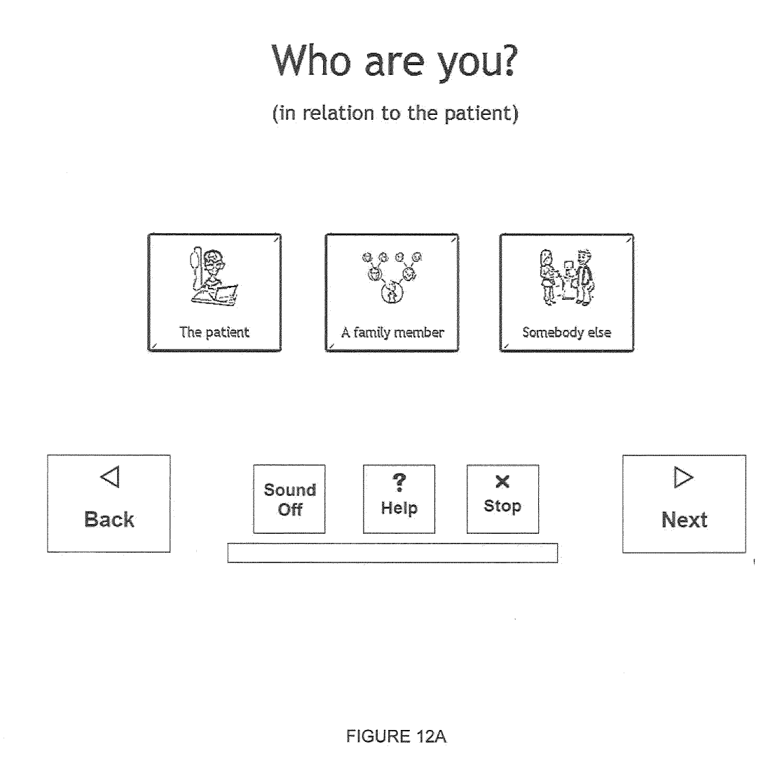

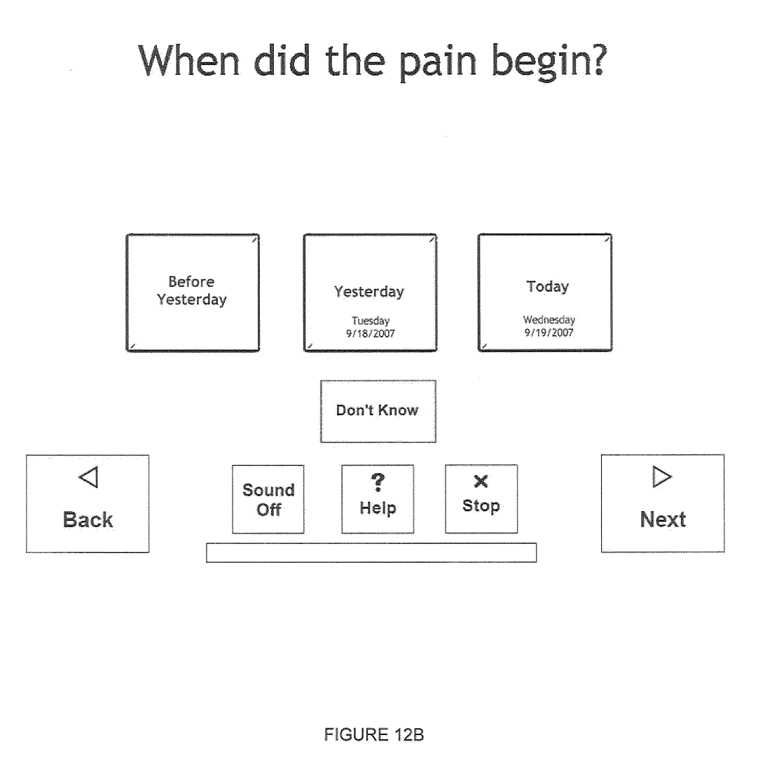

The “Pick One” formType allows the user to select one answer and one answer only. When an answer is clicked the form closes and the next question is presented. FIGS. 12A-12B illustrate examples of Pick One formTypes. FIG. 12A is a data entry screen intended to identify the person completing the patient intake information. This could be the patient themselves, a family member, or someone else. Selecting one of the responses causes that form to close and another to open based on the appropriate branch based on the selection.

FIG. 12B is another Pick One form. This form asks the user when the pain began and offers a number of choices, including “Don't Know”. This form is typically used in the Complaints module 202.

Pick Many

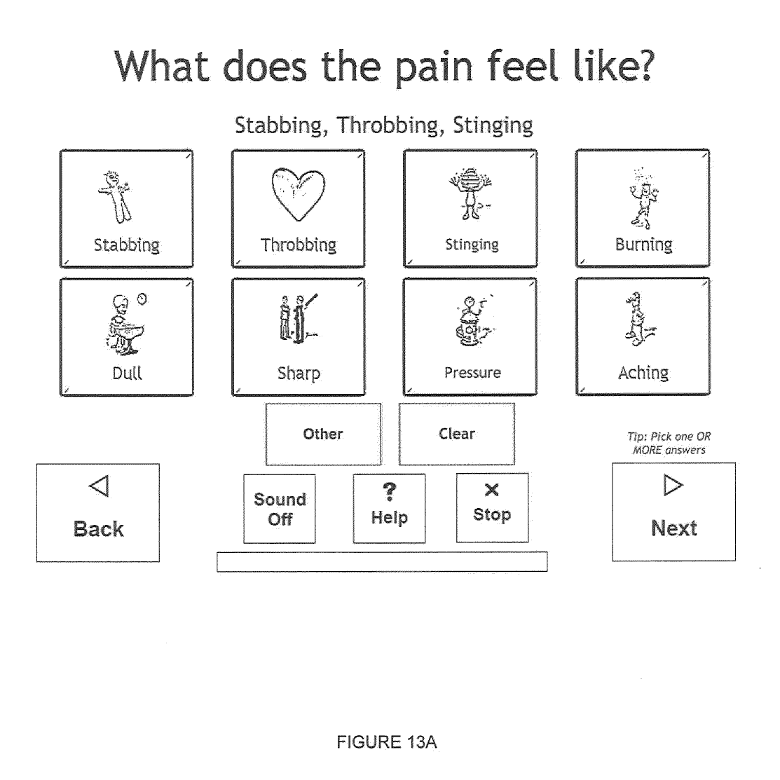

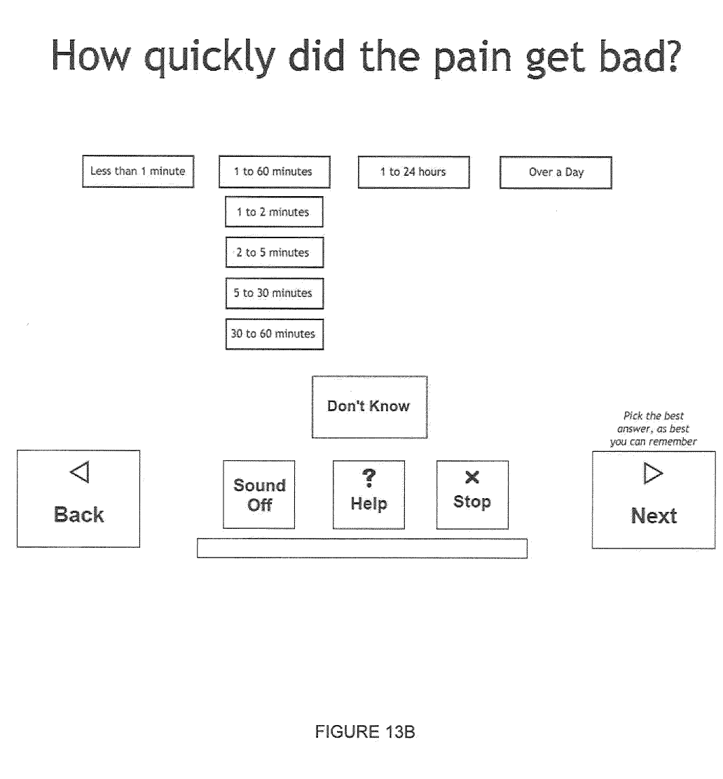

The Pick Many form is used for questions that can or should have multiple answers. FIG. 13A illustrates a pain indication form that may be used in module 202. The form presents graphical and textual descriptions of kinds of pain and invites the patient to select all that apply to the type of pain felt by the patient. In one embodiment, the graphics on each selector button are animated to provide additional information to the user about the meaning of the terms on the selector.

The “Pick Many” formType allows the user to select one or more answers. When an answer button is touched the choice is shown in a label above the buttons, which lists all the choices made. Pressing a button a second time removes it as a choice, i.e. if the user presses (in the below example) the “throbbing” button twice, that would select then de-select it. The form does not close until the user presses “Next” (or Previous). Note that the common buttons appear at the bottom of this form type and all form types as is shown below. In one embodiment the system can branch to a common path from all choices, or to different paths for any or all choices.

FIG. 13B is another Pick Many form. In this case, the form asks about how quickly the pain became bad. Here the user first selects a heading selector and then one of the entries that appear below the header selector. This is typically part of module 202.

Alpha/Numeric Form

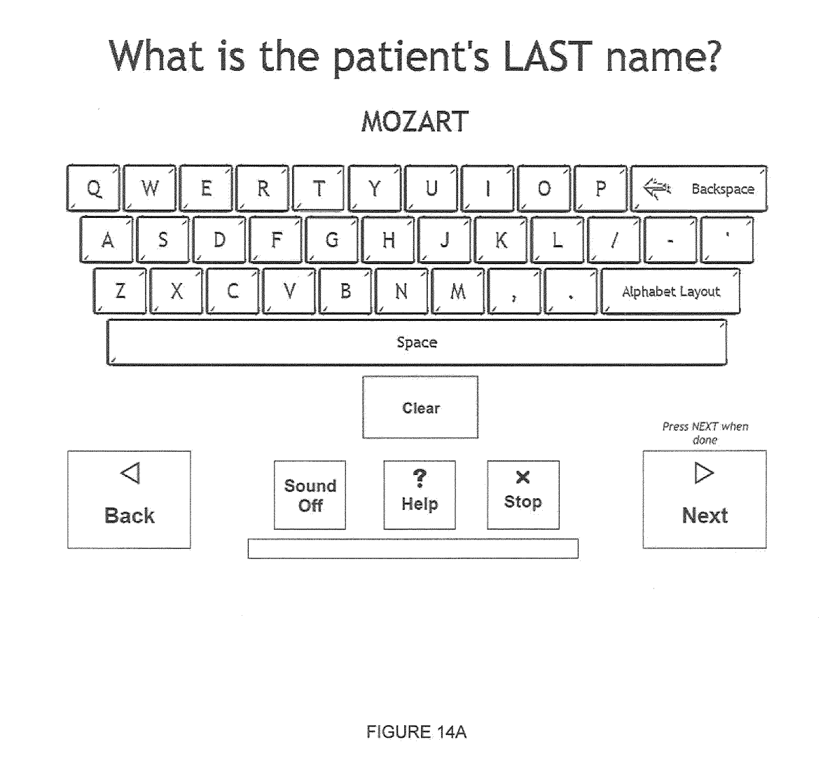

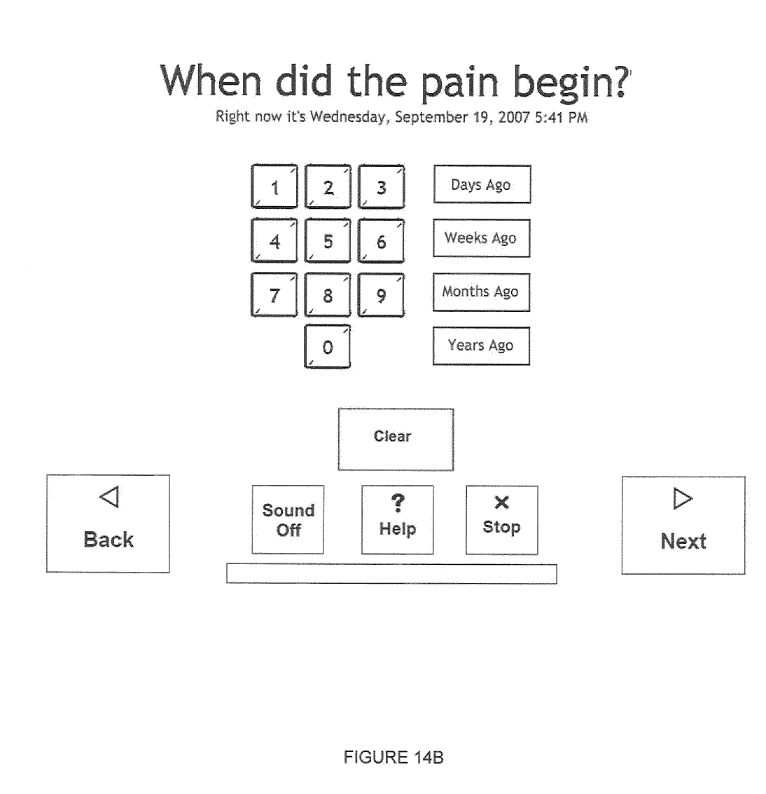

The Alpha formType allows the patient to touch letters using an on-screen touch keyboard, in either keyboard layout or alphabetic layout. Audio feedback is provided for each letter touched in one embodiment and the letters appear as they are typed for additional feedback as show in FIG. 14A.

The Numeric formType of FIG. 14B is used for the user to enter a number, with or without decimal. The system allows for minimum and maximum values for any question that calls this formType.

Interactive Form

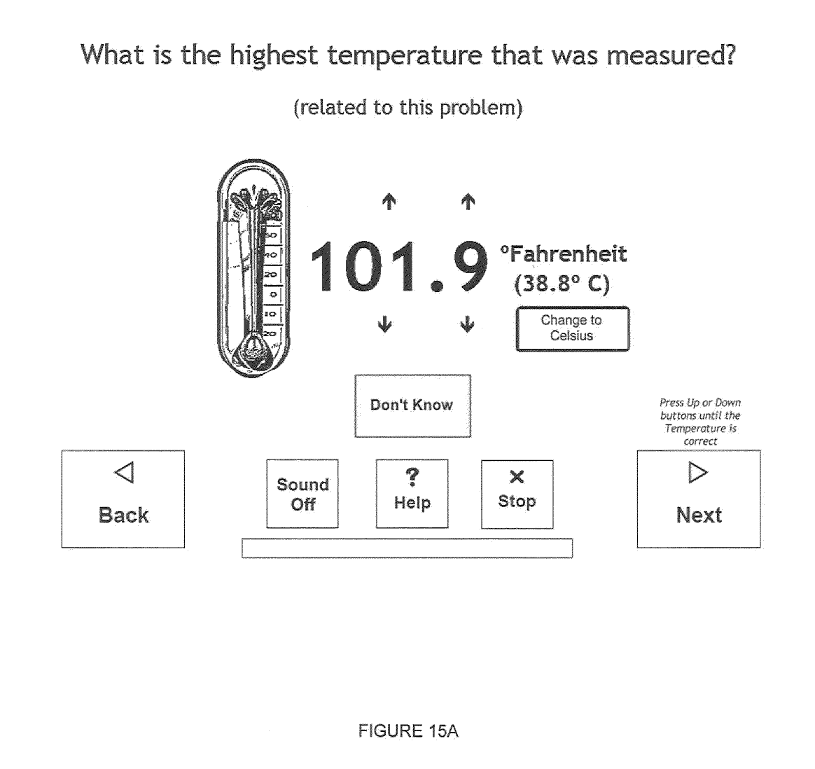

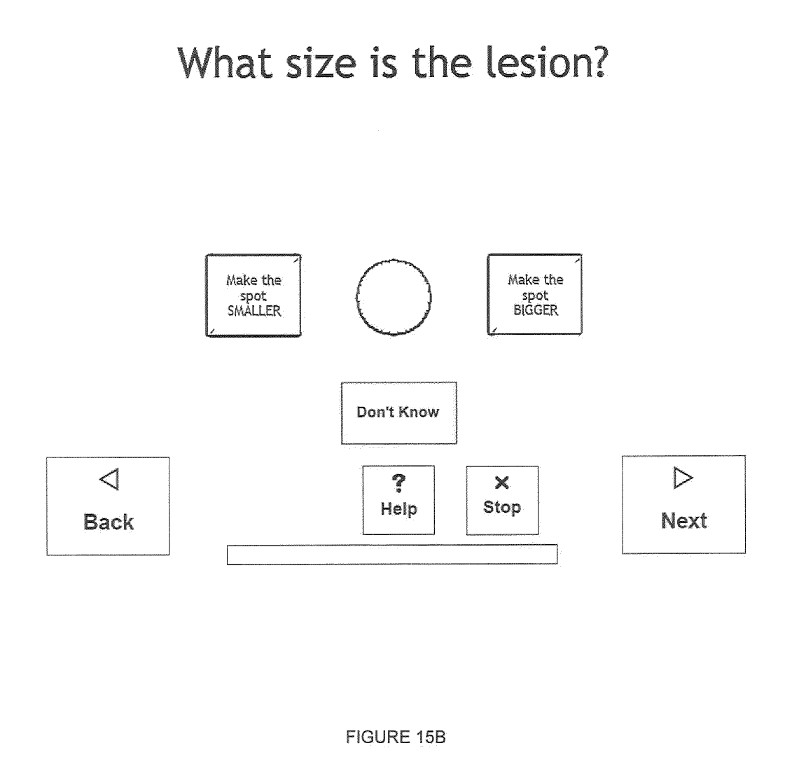

An example of an interactive form is the temperature formtype of FIG. 15A. This gathers a body temperature from the patient, in Fahrenheit or Celsius. As the patient uses the up and down arrow keys to raise and lower the temperature, the graphical thermometer goes up and down as well, providing graphical feedback to the patient. The thermometer has minimums and maximums that reflect reasonable human limits.

FIG. 15A is used by the patient to indicate the size of an affected area or the size of a lesion. The patient uses the increase and decrease selectors to make the spot larger or smaller until it approximates the size of the area on the patient. The size is translated to the doctor in a metric measurement.

Embodiment of Computer Execution Environment (Hardware)

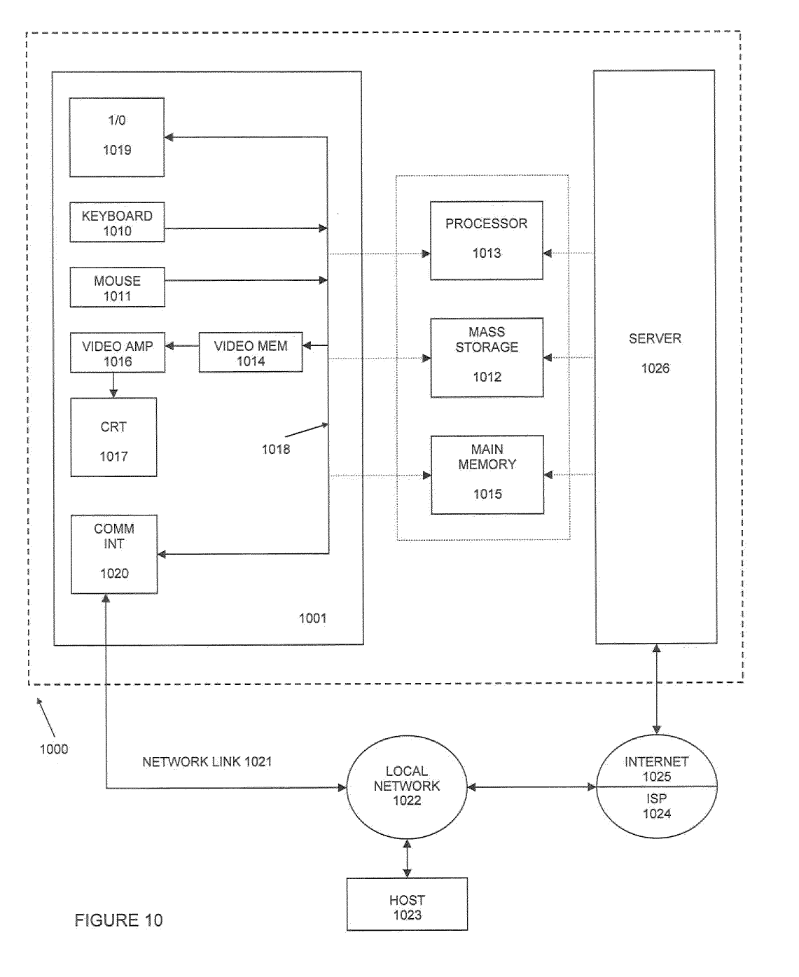

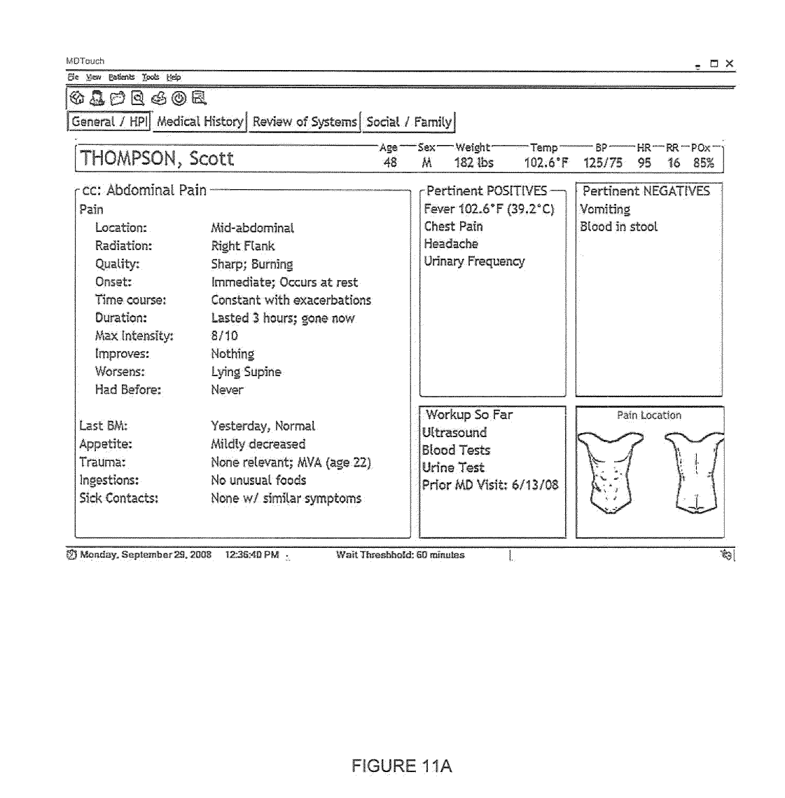

An embodiment of the system can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Patient Database

Regardless of how patient data is obtained, one aspect of the system provides for a central repository for patient information so that medical record access is streamlined. In addition to their own medical history, the patient has access to the treatment plan provided by their doctor in response to doctor visits. This reduces the risk of patient confusion because constant access to an accurate description of the medical plan is available to the patient and family members who can assist in implementing the treatment plan.

The system also provides a method for feedback from the patient to the doctor on the efficacy of the treatment. Patients are able to describe the condition of wounds, levels of pain, status of recovery, or other symptoms to the doctor on a regular basis, substituting and/or eliminating the need for follow-up doctor visits. If the treatment plan is not working as it should, the doctor will be made aware of this at the earliest opportunity so that changes in treatment can be implemented quickly. In some cases, the patient may upload pictures of an affected area so that the doctor can review progress of recovery (i.e. a wound, bruised area, swollen area, infected area, etc.).

The system also can provide third party (e.g. pharmaceutical) access or advertisements targeted to the specific condition or treatment plan of the patient. This provides specific and important information to the patient in a focussed manner, instead of requiring the patient to search out appropriate treatments or drugs.

FIG. 22 is a flow diagram illustrating the operation of advertiser use of the system. At step 2201 the patient intake process is initiated. At step 2202 the data is transmitted to a central database. This may occur during the data entry process and/or at the end of the data entry process by the patient, during the provider review and use of the process, during follow up feedback steps, or during a review of the database by the system itself. At step 2203 the received data is analyzed to determine if a trigger or trigger condition is met. A trigger may be the presence of a word, phrase, area of discomfort, type of illness, etc. that a patient may indicate. A trigger condition may be some combination of responses that have been defined by one or more potential advertisers. At decision block 2204 it is determined if a trigger is present. If so, the system proceeds to decision block 2205 to determine if there is an advertiser associated with the trigger. If so, the system retrieves an ad associated with the trigger and the advertiser and serves the ad at step 2206. This ad may be served to the patient and/or the provider depending on the nature of the trigger and the ad. If there is no trigger and negative responses at decision blocks 2204 and 2205, the system ends.

In one embodiment as noted above, the system includes an interactive computer based questionnaire that guides a patient through an intake procedure using text, graphics, video, and audio. The system includes intuitive and simple navigation and allows the patient to easily back up to any previous section to revise answers.

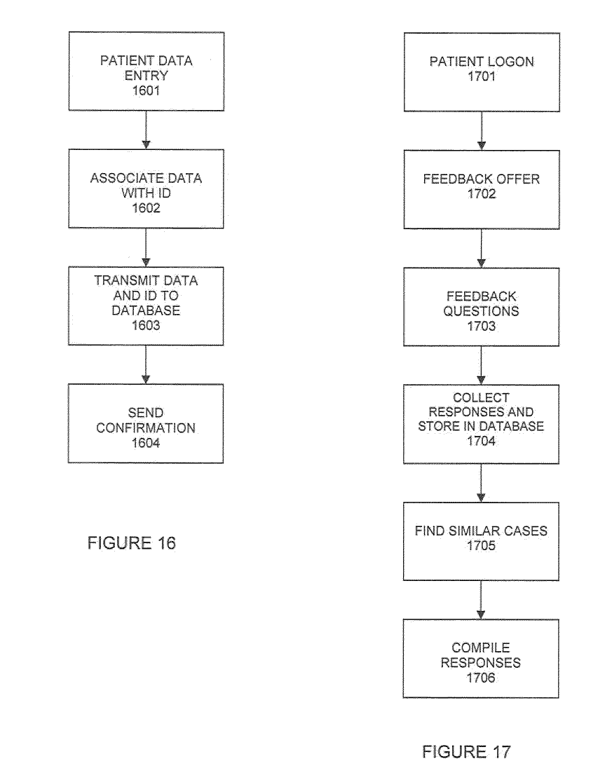

FIG. 16 is a flow diagram of data entry and storage in one embodiment of the system. At step 1601, the patient enters information into some data entry system. This can be a hand held tablet purpose built for such data entry. In another embodiment, it could be a general purpose computer configured with software to elicit the patient information. In other embodiments, it could be data obtained by a medical professional and entered into a computer system contemporaneously or subsequently. At step 1602 the data is associated with a unique identifier (i.e. a unique patient ID). The data and identifier are transmitted to a central database at step 1603 and are added to any existing records associated with that patient ID. At step 1604 a confirmation is sent to the patient and/or medical professional confirming that the records database has been updated.

FIG. 17 is a flow diagram illustrating the operation of one embodiment of the feedback system. At step 1701 the patient logs onto the patient database and accesses the patients records. At step 1702 the patient is presented with an opportunity to provide feedback to the system. If the patient elects to participate, the system proceeds to step 1703 and presents the patient with a series of questions related to the patient experience with the medical professional, the patient's satisfaction with the treatment plan, reaction to any medications or drugs, change (positive or negative) to the condition prompting the visit, rating of the doctors manner and performance, etc. At step 1704 the system collects the patient responses and stores them in the database. At step 1705 the system determines if there are other patients in the database with the same or closely related diagnoses and/or treatment plans. If so, at step 1706 the system adds the current patient responses to a summary database associated with those conditions. In this manner, the system can compare different patients with similar conditions and/or treatment plans to determine the efficacy of the treatment plans and diagnosis. The system can sort this data demographically as well by sex, age, geographical region, etc. In addition, the response may be sent to the attending medical professional so that patient response can be understood.

Family Connections

A typical question asked by healthcare providers of a patient is the medical history of the family of the patient. This information can have an important affect on diagnosis and treatment. Presentation of the same symptoms in two different patients can lead to different diagnoses depending on family history. Even if a similar diagnosis is reached for each patient, the treatment plan for each may be different due to family history considerations. The family history is thus very important information to have available.

Unfortunately, the family history portion for a patient is often the least reliable and most incomplete section of a patients records. A patient is most likely only aware of significant medical events or conditions of immediate family members. Even in those cases, a patient who is under stress from their own current medical condition may not remember with clarity and completeness the history of other family members. The system provides a method for more complete family medical history information by allowing family members to create relationship associations with other family members through the database of the system. When two family members have created this association and given permission for family history sharing, the family history portion of each of them is always current at least with respect to the other participating family members.

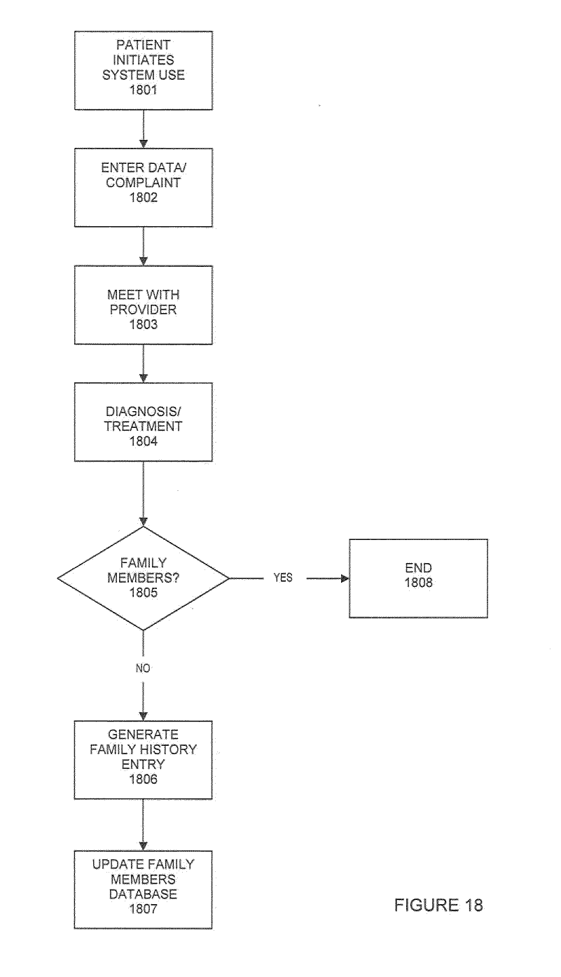

FIG. 18 is a flow diagram illustrating one embodiment of the operation of the family connection scheme of the system. At step 1801 a patient uses the intake/database tools of the system as part of an interaction with a provider. At step 1802 the patient enters data associated with the present visit and at step 1803 the patient has a session with the provider. At step 1804 the provider enters a diagnosis and treatment plan for the patient. At step 1805 the system checks to see if there are other family members associated with this patient. If so, the system proceeds to step 1806 to generate a family history entry for each of the associated family members. The family history database entry may be a variation of the data that would be entered into the patients own database. For example, it may just indicate the familial relationship (e.g. sibling, parent, grandparent, etc). along with the diagnosis/treatment. In other embodiments, the family history entry could be more detailed, including most or all of the data that would be present in the patients own database. At step 1807 the family history entry is transmitted to the database entries for each associated family member. If there are no associated family members at step 1805, the system ends at step 1808.

By implementing the family history system, each associated family member has their respective family medical history section immediately updated by the system, even if they are unaware of the visit by the current patient. This provides a more accurate family medical history that can help improve diagnoses and treatment plans.

Provider Use/Presentation of Family History

The system in one embodiment provides a number of ways to filter and present the family history information to the provider. In some cases the provider is presented with a high level summary of all participating family members during the diagnosis process. This enables the provider to make use of the family history in the diagnosis phase. In addition, once the diagnosis has been made, the system may search the family history database for any similar diagnoses for other family members and alert the provider. The information may include the treatment plans of the other similarly diagnosed family members and the efficacy of those plans. This may enable the provider to detect a pattern or preference of treatment for family members that may have an impact on the providers decision on a treatment plan for the current patient.

Patient Access to Records

The system contemplates that the patient can access the records database at any time. The database may also be linked to third party advertisers. The system can provide context sensitive information and advertising to patient users of the site. For example, if there is a new treatment for a particular condition, any patient whose records indicate that condition can be provided with articles or other information about the new treatment. The patient can also be directed to ads that offer medicine or other treatments related to that condition. In one embodiment, the system includes an email account tied to the patient ID so that these offers can be provided even when the patient does not log onto the database server.

In another embodiment, the patient can opt to create or populate an existing patient account in a third party online personal health record. For example, an online personal health record referred to as HealthVault and provided by Microsoft is available. There are other systems offered by others, including AOL, Google, and others. Any suitable online personal health record can be used without departing from the scope or spirit of the system. The system provides for a patient to opt to transfer the patient's data generated using the system to an online personal health record to automatically update or populate an existing account, or to create a new online personal health record account.

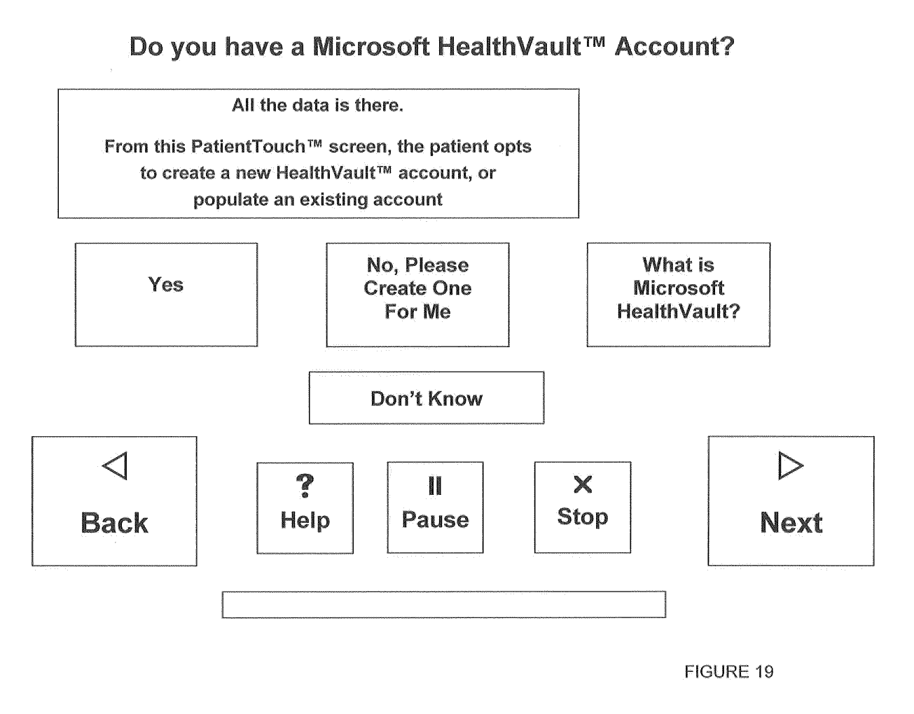

In one embodiment, the system provides a mapping between fields in the patient data entry system and fields in third party patient online personal health record. FIG. 19 illustrates an embodiment of a data entry screen that may prompt the patient to update or create a HealthVault account. When elected, the system transmits the appropriate data to the HealthVault account, handling any mapping of fields as required by the destination system. Although HeathVault is shown in FIG. 19, any online personal health record may be used.

In another embodiment, the patient may be asked if the patient already has an online personal health record. In that case, the patient may choose to allow the system to retrieve data from the online personal health record to save time in data entry. This allows the patient to then focus on entering data about whatever the current issue is for which the patient is seeking treatment.

Data Trend Collection and Analysis

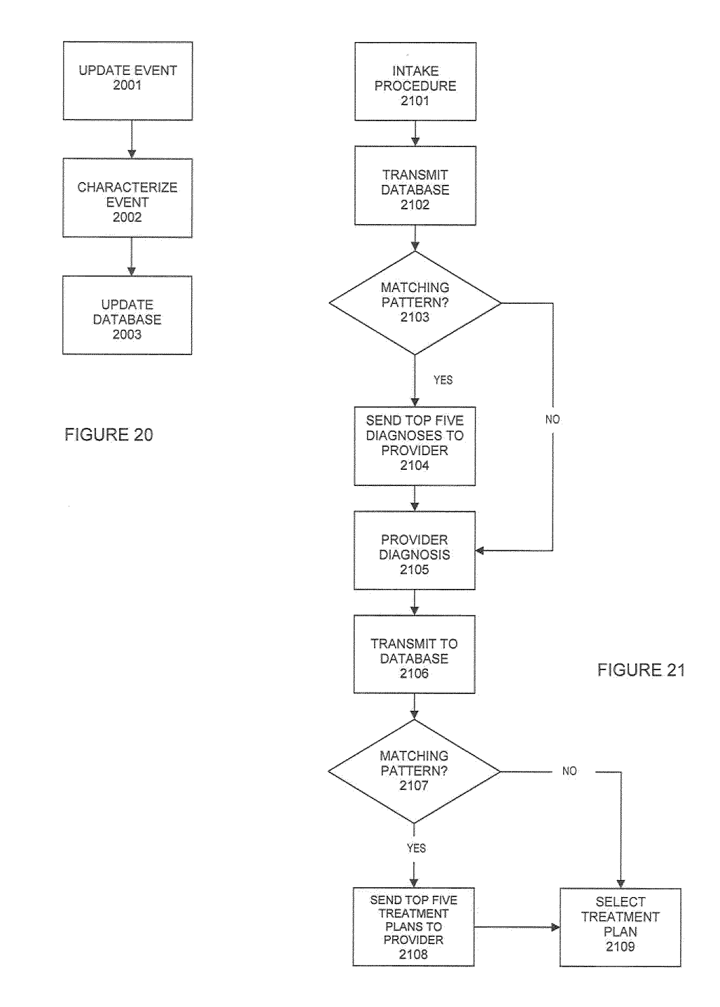

The system can have particular usefulness as a tool to aid in identifying trends, disease transmission, epidemic information and other useful statistical information. FIG. 20 is a flow diagram illustrating a data collection method of the system. At step 2001 a provider and patient use the system to in a way that results in a data update for a patient. This could be the generation of a diagnosis or treatment plan. The activity at step 2001 might also be an update on the efficacy of a treatment plan. At step 2002 the update is characterized appropriately. For a diagnosis, this could be accomplished by characterizing the diagnosis by a predefined data entry made available to the provider (e.g. flu, infection, virus, broken leg, etc.). For a treatment plan, this might be characterized by a prescription panel, antibiotics, or other aspects of a treatment plan. Typically the treatment plan would be associated with a prior diagnosis. For follow up efficacy, such and update would be associated with the prior diagnosis and the current treatment plan.

At step 2003 the update is transmitted to the central database and the database is appropriately updated. This update could be some combination of populating a histogram, updating a geographical frequency chart, by demographics, by age, sex, or other characteristics. For a diagnosis, the central database may include the answers given by patients using the intake system. The system can then analyze the various response patterns that have led to the diagnosis.

The collected data can be used to identify possible outbreaks of disease, spread of epidemics, differences in treatment plan by demographic category, and other useful information.

Provider Assist

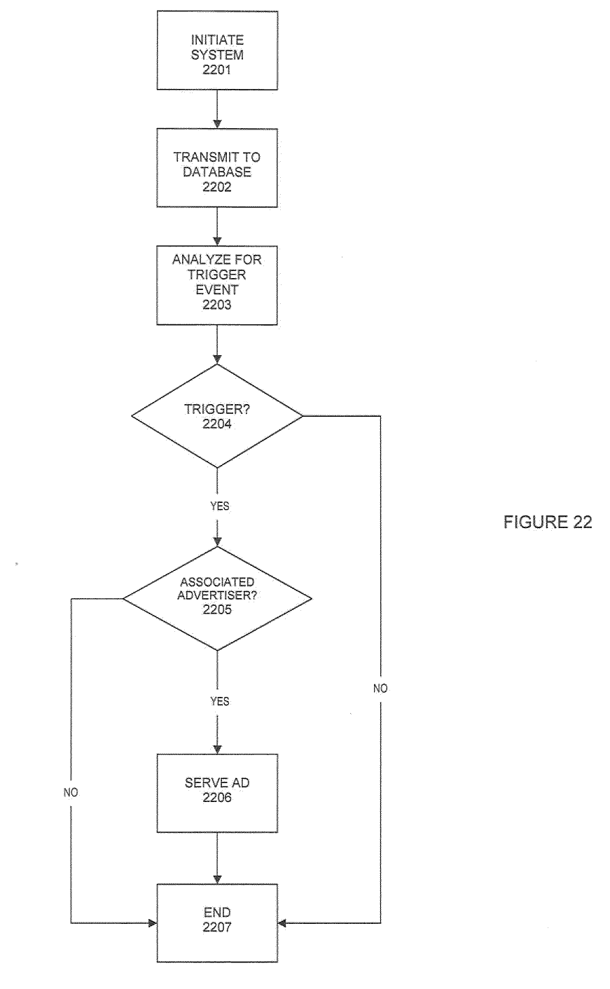

The existence of the central database of diagnoses, treatment plans, and efficacy data may be used by the system in one embodiment to provide trend or other useful information to a provider. FIG. 21 is a flow diagram illustrating one embodiment of this aspect of the system. At step 2101 a patient goes through the data intake procedure of the system. At step 2102 the response that the patient has selected are transmitted to the central database. At decision block 2103 the system determines if there are any matching patterns to the patient responses. This step may be for an exact match of responses or it may to some set or response that are statistically related. If there is a match at step 2103, the system determines the top five diagnoses that are associated with that pattern of responses. In one embodiment, this search can be filtered by demographic information, including gender, age, geography, relevant family history, etc. At step 2104 the system sends the top five diagnoses associated with the pattern of the patients responses to the provider. This is not intended to replace the diagnosis of the local provider, but as a tool to assist the provider.

After step 2104, or if there is no matching pattern at step 2103, the provider makes a diagnosis and enters it into the system. This may be prior to, subsequent to, or contemporaneously with discussing the diagnosis with the patient. At step 2106 the diagnosis is transmitted to the central database. At decision block 2107 the system checks to see if there are similar diagnoses in the database. Again, this check may be done with demographic filtering as described above. If the diagnosis has been made before in the system, the system sends the top five treatment plans to the provider at step 2108. The top five plans may be based on simple frequency of times prescribed, by ranking the efficacy of different treatment plans during feedback operations, or some combination of the two. After step 2108 or if there are no matches at step 2107, the system proceeds to step 2109 and the provider prescribes a treatment plan.

Thus, a patient database has been described.

What is claimed is:

1. A method for storing patient information comprising:
collecting patient information;
storing the patient information in a database;
providing access to the database to the patient and medical professionals.

2. The method of claim 1 further including the step of providing advertising based on the information in the database.

3. The method of claim 1 further including the step of associating patient information of family members in the database.

4. The method of claim 3 further including the step of automatically updating a family history portion of a patient's database with information from associated family members.

5. The method of claim 1 further including the step of comparing the data of all users of the database with data from the patient.

6. The method of claim 5 further including the step of suggesting a diagnosis to a medical professional based on the comparison.

7. The method of claim 5 further including the step of suggesting a treatment plan to a medical professional based on the comparison.

8. The method of claim 1 further including the step of providing treatment efficacy data to the database.

9. The method of claim 1 further including the step of analyzing the database for a trigger event.

10. The method of claim 9 further including the step of serving an ad based on the presence of a trigger event.
